(19) United States
(12) Patent Application Publication
(10) Pub. No.: US 2002/0189459 A1
(43) Pub. Date: Dec. 19, 2002

(54) Isolation mechanism for trailer air dryer

(75) Inventors: Fred Hoffman, Columbia Station, OH (US); Leonard Quinn, Elyria, OH (US); James Koenig, Olmsted Township, OH (US)

Correspondence Address: Paul L. Marshall, Honeywell Commercial Vehicle Systems Company, 901 Cleveland Street, Elyria, OH, 44035, US

(73) Assignee: Honeywell Commercial Vehicle Systems Company

(21) Appl. No.: 09/880,281

(22) Filed: Jun. 13, 2001

(51) Int. Cl. B01D 53/02

(52) U.S. Cl. 96/147

(57) ABSTRACT

An isolation mechanism is provided for a trailer air dryer to limit transfer of forces from a trailer frame to the dryer. In a first embodiment, elastomeric bushings are interposed between the trailer frame and the dryer to reduce the forces transferred to end covers of the trailer dryer. In another embodiment, the mounting assembly is modified to include a connection directly to a central body of the air dryer. In yet another embodiment, U-shaped fasteners couple the body of the air dryer to the frame.

### BACKGROUND OF THE INVENTION

1. Field of Invention

This invention relates to an air dryer system for use in a compressed air system. More particularly, the invention relates to an air dryer system used in a trailer, and an apparatus and method for isolating forces transmitted to the trailer air dryer.

2. Discussion of the Art

Commonly-owned U.S. patent application Ser. No. ______ filed ______, entitled “Air Dryer with Bypass Valving and Service Indicator” (Attorney Docket No. 591-99-020) discloses a dedicated trailer air dryer for removing entrained moisture from compressed air associated with trailer needs. The trailer dryer has a housing which includes a body that is preferably an aluminum extrusion because of the simplicity and cost effectiveness to manufacture, although alternative constructions are contemplated. A drying material, such as a desiccant or other drying agent, is contained within housing passages and one or more filter members are preferably used to assist in removing particles in the air flow. End covers are disposed at opposite ends of the body to hold components of the trailer dryer in place. The housing is secured to the trailer via the end covers. That is, fasteners secure the end covers to the aluminum body and additional fasteners extend generally perpendicular from the first set of fasteners and the longitudinal extent of the aluminum body to secure the housing at two spaced locations along the frame.

Typically, during installation of the trailer dryer, the trailer is empty. The trailer is subsequently loaded when put into service and the frame or cross member to which the trailer dryer is secured undergoes flexing or deflection. This flexing imparts additional stress forces on the fasteners of the trailer dryer. Accordingly, it is deemed desirably to prevent or limit the stress forces from being transmitted to the trailer dryer, particularly the fasteners that secure the end covers to the body of the housing.

### SUMMARY OF THE INVENTION

The present invention relates to an isolation mechanism to limit the transfer of forces from the trailer frame to a trailer air dryer.

An air dryer housing includes an inlet for receiving compressed air and an outlet for providing dry air for trailer use. A mounting assembly secures the housing to an associated trailer frame. An isolation mechanism is operatively associated with the housing and the mounting assembly to limit the force transfer from the trailer frame to the housing.

In one preferred embodiment, the isolation mechanism includes an elastomeric bushing disposed between the trailer frame and the housing.

In another embodiment, a slot is formed on a portion of the trailer dryer to receive a fastener and preclude transfer of forces to the end plate fasteners.

Still another embodiment uses U-shaped fasteners configured to the outside contour of the trailer dryer body for securing the air dryer to the frame.

A primary advantage of the invention is the ability to limit mounting stresses from being transmitted to the fasteners that hold the dryer together.

Still another advantage of the invention is the ease with which low cycle fatigue can be eliminated.

Still other advantages and benefits of the invention will become apparent to those skilled in the art upon reading and understanding the following detailed description.

### BRIEF DESCRIPTION OF THE DRAWINGS

FIG. 1 is an exploded assembly view of the air dryer and components securing it to a trailer frame in accordance with the present invention.

FIG. 2 is a cross-sectional view of the air dryer body.

FIG. 3 illustrates a second preferred embodiment for securing the trailer dryer in an effort to limit the transfer of stress forces.

FIG. 4 illustrates yet another embodiment of the present invention.

### DETAILED DESCRIPTION OF THE PREFERRED EMBODIMENTS

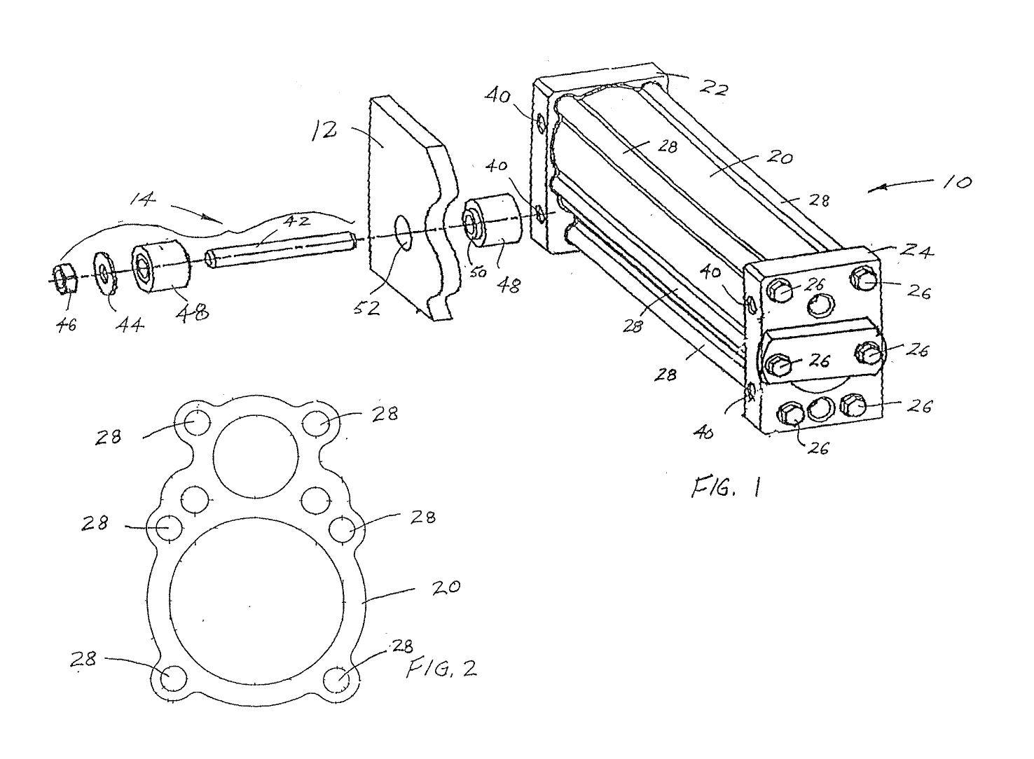

The preferred embodiment of the invention is illustrated in FIG. 1 and includes a trailer air dryer 10 mounted to a frame 12 via a mounting assembly 14. As indicated above, details of the trailer dryer 10 can be found in the commonly-owned, copending application Ser. No. ______, and thus not all of the structural and functional details will be presented here. The dryer includes a housing having a central portion or body 20 which is preferably an elongated, aluminum extrusion. The body is closed at opposite ends by first and second end covers or end plates 22, 24. The end covers are secured via fasteners 26, which in a preferred arrangement are six hardened, zinc plated bolts. The bolts self-tap into the aluminum body 20, particularly into the walls that define elongated, hollow openings 28 in the body (see FIG. 2). The openings add desired rigidity and strength to the body and since the aluminum is a relatively soft material, allows the fasteners 26 to self-tap into opposite ends of the bodies and secure the end covers in a tight, sealed relationship. It will be appreciated that a greater or lesser number of fasteners and elongated openings can be used without departing from the scope and intent of the present invention.

To secure the air dyer to the frame, threaded openings 40 are provided in the end covers 22. This provides sufficient support for securing the trailer dryer to the frame. However, as noted above, flexing or deflection of the frame is then transmitted to opposite ends of the trailer dryer through these fastener connections. This, in turn, imposes undesirable stresses on fasteners 26 that secure the end covers to the body. Since it is important that the end covers securely engage opposite ends of the body 20 in a sealed relationship and to increase the useful life of these fasteners, an isolation mechanism is required.

In the embodiment of FIG. 1, the mounting assembly 14 includes a threaded stud 42, washer 44, and threaded nut 46 to secure the air trailer dryer to the frame. The isolation mechanism includes first and second elastomeric bushings 48 disposed on opposite sides of the frame and concentrically received about the threaded stud or fastener 42. Preferably, each elastomeric bushing is comprised of hollow, concentric sleeves in which the inner sleeve has a diameter 50 adapted for mating receipt in opening 52 of the frame. This accurately locates the bushing between the frame and end plate, and likewise between the frame and washer/nut 44, 46 of the mounting assembly. The elastomeric nature of the bushings absorbs the forces that would otherwise be undesirably transferred to the trailer dryer upon flexing of the frame. It will also be appreciated that although only one mounting assembly and isolation mechanism is illustrated in FIG. 1, a similar mounting assembly is provided for each of the mounting locations 40 of the end covers.

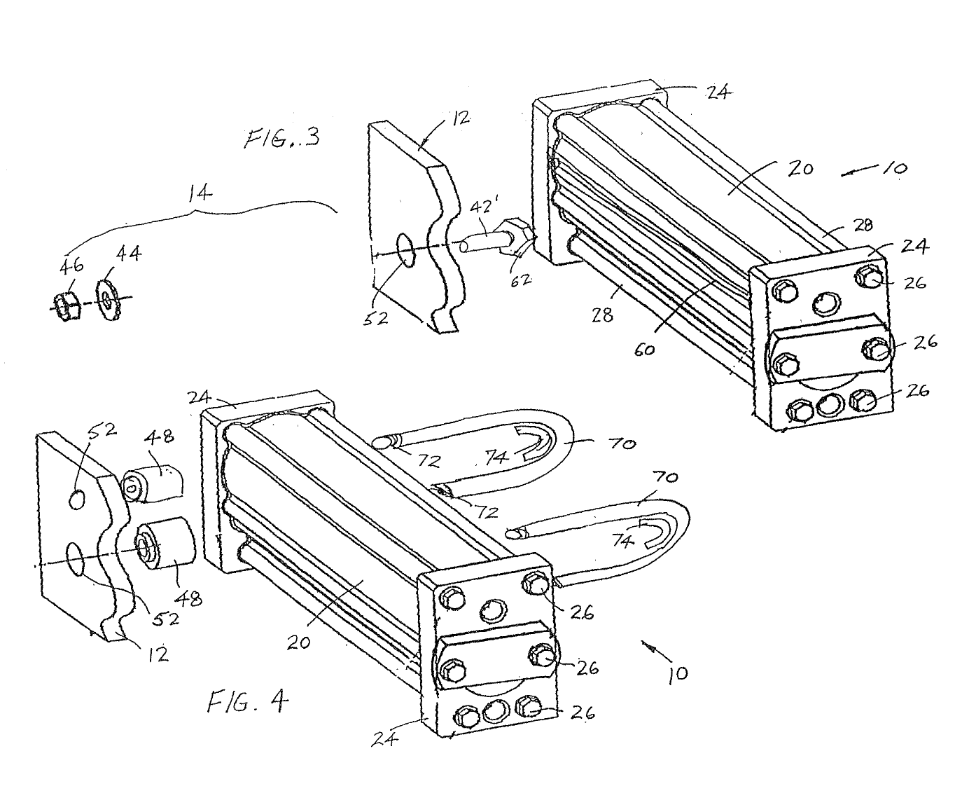

In FIG. 3, the isolation mechanism is comprised of an elongated slot, such as a T-shaped slot 60 integrally extruded into the body of the trailer dryer. A T-shaped slot is preferred since it is dimensioned to capture the head 62 of a fastener such as a bolt and allow the mounting forces to be directly transferred from the frame, to the mounting fastener, and to the body of the trailer dryer. This eliminates the transfer of mounting forces through the end covers as has been done in the past, or at a reduced level in association with the embodiment of FIG. 1. Likewise, if desired, an elastomeric material may be interposed between the housing and the frame, i.e., with the mounting arrangement, if desired, to limit transfer of forces from the frame to the dryer.

FIG. 4 illustrates a modified construction. Rather than using the end covers for securing to the frame as in FIG. 1, or a slot 60 as provided in the FIG. 3 embodiment, U-shaped fasteners or bolts 70 are used. The U-bolts 70 are provided as separate components and provision made to the body 20 to conform thereto and evenly distribute the forces about the body. Again, however, the mounting forces are transferred from the frame to the U-bolts 70 and directly to the body, rather than being transferred to the end covers. Again, elastomeric components can be used, such as a bushing 48 provided at threaded end 72 of the U-bolts or elastomeric bearing pads 74 provided at the base of the U-shaped fastener.

The invention has been described with reference to the preferred embodiments. Obviously, modifications and alterations will occur to others upon a reading and understanding of the detailed description. The invention is intended to include all such modification and alterations insofar as they come within the scope of the appended claims and the equivalents thereof.

Having thus described the invention, it is claimed:

1. A trailer air dryer adapted to be mounted on a trailer frame comprising:
an air dryer housing having an inlet for receiving compressed air and an outlet for providing dry air for trailer uses downstream thereof;
a mounting assembly adapted to secure the housing to an associated trailer frame; and
an isolation mechanism operatively associated with the housing and the mounting assembly to limit the transfer of forces from the trailer frame to the housing.

2. The trailer air dryer of claim 1 wherein the isolation mechanism includes an elastomeric bushing interposed between the trailer frame and the housing.

3. The trailer air dryer of claim 2 wherein the mounting assembly includes a stud that operatively engages the housing to the frame.

4. The trailer air dryer of claim 3 wherein the isolation mechanism includes an elastomeric bushing received about the stud and interposed between the trailer frame and the housing.

5. The trailer air dryer of claim 4 wherein the isolation mechanism includes a second elastomeric bushing received about the stud.

6. The trailer air dryer of claim 5 wherein the bushings are disposed on opposite sides of the frame.

7. The trailer air dryer of claim 1 wherein the mounting assembly includes first and second mounting locations at a first end of the housing and a third mounting location at a second end of the housing.

8. The trailer air dryer of claim 1 wherein the trailer frame includes an opening therethrough for receiving the mounting assembly, the isolation mechanism includes an elastomeric bushing interposed between the trailer frame and the housing, the elastomeric bushing including a first portion having a reduced dimension adapted for receipt within the trailer frame opening and a second dimension having a dimension greater than the opening.

9. The trailer air dryer of claim 8 wherein the elastomeric bushing includes first and second hollow sleeves received about a fastener interconnecting the frame and housing.

10. The trailer air dryer of claim 1 wherein the isolation mechanism includes first and second hollow, elastomeric sleeves received about a fastener interconnecting the frame and housing.

11. An elongated trailer air dryer mounted on a trailer frame comprising:
an air dryer housing containing a desiccant for entraining moisture from air passing through the housing between an inlet and an outlet prior to use downstream of the housing;
a mounting assembly securing the housing to a trailer frame; and
an isolation mechanism operatively associated with the housing and the mounting assembly to limit the transfer of forces from the trailer frame to the housing.

12. The trailer air dryer of claim 11 wherein the isolation mechanism includes an elastomeric bushing interposed between the housing and the trailer frame.

13. The trailer air dryer of claim 11 wherein the mounting assembly includes fasteners interconnecting the trailer frame and the housing, the isolation mechanism includes an elastomeric bushing interposed between the housing and the trailer frame.

14. The trailer air dryer of claim 11 wherein the isolation mechanism includes a slot provided in the housing, and the slot receiving a fastener.

15. The trailer air dryer of claim 11 wherein the isolation mechanism includes at least one U-fastener received around the housing and free ends of the fastener secured to the frame.

16. A method of mounting a trailer air dryer on a trailer frame comprising the steps of:
fastening an air dryer housing to the trailer frame; and
providing an isolation mechanism operatively associated with the housing and the mounting assembly to limit the transfer of forces from the trailer frame to the housing.
